(19) United States
(12) Patent Application Publication
(10) Pub. No.: US 2023/0307710 A1
(43) Pub. Date: Sep. 28, 2023

(54) NONAQUEOUS ELECTROLYTE AND NONAQUEOUS ELECTROLYTE SECONDARY BATTERY INCLUDING THE SAME

(71) Applicant: Prime Planet Energy & Solutions, Inc., Tokyo (JP)

(72) Inventor: Hiroto ASANO, Nisshin-shi (JP)

(21) Appl. No.: 18/190,128

(22) Filed: Mar. 27, 2023

(30) Foreign Application Priority Data
Mar. 28, 2022 (JP) 2022-051374

(51) Int. Cl. H01M 10/0567; H01M 10/0525

(52) U.S. Cl. CPC H01M 10/0567; H01M 10/0525; H01M 2300/0025

(57) ABSTRACT

Provided is a nonaqueous electrolyte that can provide a secondary battery with both excellent initial output characteristics and excellent high-temperature storage characteristics. A nonaqueous electrolyte disclosed here includes an electrolyte salt, a nonaqueous solvent, and a compound represented by following Chemical Formula (I):

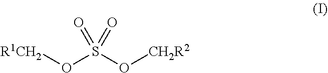

where each of R¹ and R² independently represents a trifluoromethyl group, a secondary alkyl group having 3 to 6 carbon atoms, or a tertiary alkyl group having 4 to 6 carbon atoms.

### TECHNICAL FIELD

The present disclosure relates to a nonaqueous electrolyte. The present disclosure also relates to a nonaqueous electrolyte secondary battery including the nonaqueous electrolyte. This application claims the benefit of priority to Japanese Patent Application No. 2022-051374 filed on Mar. 28, 2022. The entire contents of this application are hereby incorporated herein by reference.

### BACKGROUND

Recent nonaqueous electrolyte secondary batteries such as lithium ion secondary batteries are suitably used for, for example, portable power supplies for devices such as personal computers and portable terminals, and vehicle driving power supplies for vehicles such as battery electric vehicles (BEVs), hybrid electric vehicles (HEVs), and plug-in hybrid electric vehicles (PHEVs).

With widespread use of nonaqueous electrolyte secondary batteries, these batteries are required to have further enhanced performance. One of measures for enhancing performance of a nonaqueous electrolyte secondary battery is to improve a nonaqueous electrolyte by using an additive. Patent Document 1, for example, describes that addition of a sulfate ester compound to a nonaqueous electrolyte as an additive contributing formation of a coating on an electrode results in significant suppression of an increase in internal resistance at low temperatures of a battery after usage in a high-temperature environment.

### CITATION LIST

### Patent Document

Patent Document 1: JP2012-9370A

### SUMMARY OF THE INVENTION

For the increasing demand for properties of nonaqueous electrolyte secondary batteries, it is not easy to achieve high levels of both initial output characteristics (i.e., low resistance) and durability (i.e., suppression of capacity decrease and resistance increase). In particular, in the case of improving a nonaqueous electrolyte by using an additive serving as a coating forming component, since a coating is an insulator, when durability is increased by the coating, resistance tends to increase. For the durability, a cause of capacity decrease and a cause of resistance increase are different. Through an intensive investigation, the inventors of the present disclosure have found that a nonaqueous electrolyte secondary battery including a conventional nonaqueous electrolyte has the problem of difficulty in achieving high levels of both initial output characteristics and storage characteristics at high temperatures.

It is therefore an object of the present disclosure to provide a nonaqueous electrolyte that provides a secondary battery with excellent initial output characteristics and excellent high-temperature storage characteristics.

A nonaqueous electrolyte disclosed here includes an electrolyte salt, a nonaqueous solvent, and a compound represented by following Chemical Formula (I):

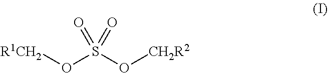

where each of R¹ and R² independently represents a trifluoromethyl group, a secondary alkyl group having 3 to 6 carbon atoms, or a tertiary alkyl group having 4 to 6 carbon atoms.

This configuration can provide a nonaqueous electrolyte that provides a secondary battery with both excellent initial output characteristics and excellent high-temperature storage characteristics. The effect of enhancing initial output characteristics and the effect of enhancing high-temperature storage characteristics are particularly high in a case where a content of the compound represented by Chemical Formula (I) is 0.05 mass % or more and 3.0 mass % or less.

In a desired embodiment of the nonaqueous electrolyte disclosed here, the nonaqueous electrolyte further includes a compound represented by following Chemical Formula (II):

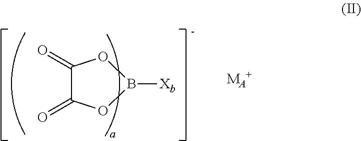

where X represents a halogen atom, M_{A}⁺ represents an alkali metal ion, a is 1 or 2, and b is 2 if a is 1, or is 0 if a is 2.

This configuration further enhances high-temperature storage characteristics (particularly resistance to capacity decrease in high-temperature storage) of a nonaqueous electrolyte secondary battery. In addition, initial output characteristics of the nonaqueous electrolyte secondary battery can be further enhanced. The advantages obtained by the compound represented by Chemical Formula (II) are particularly high in a case where a content of the compound represented by Chemical Formula (II) in nonaqueous electrolyte is 0.1 mass % or more and 1.0 mass % or less.

In a desired embodiment of the nonaqueous electrolyte disclosed here, the nonaqueous electrolyte further includes the compound represented by Chemical Formula (II) above and a compound represented by following Chemical Formula (III):

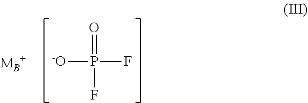

where M_{B}⁺ represents an alkali metal ion.

This configuration further enhances initial output characteristics and also further enhances high-temperature storage characteristics (particularly suppression of resistance increase in high-temperature storage). The advantages obtained by using both the compound represented by Chemical Formula (II) and the compound represented by Chemical Formula (III) are particularly high in a case where a content of the compound represented by Chemical Formula (III) is 0.05 mass % or more and 2.0 mass % or less.

In another aspect, a nonaqueous electrolyte secondary battery disclosed here includes a positive electrode, a negative electrode, and the nonaqueous electrolyte described above. This configuration can provide the nonaqueous electrolyte secondary battery with both excellent initial output characteristics and excellent high-temperature storage characteristics.

### BRIEF DESCRIPTION OF THE DRAWINGS

FIG. 1 is a cross-sectional view schematically illustrating an internal structure of a lithium ion secondary battery according to one embodiment of the present disclosure.

FIG. 2 is a schematic disassembled view illustrating a structure of a wound electrode body of a lithium ion secondary battery according to one embodiment of the present disclosure.

### DETAILED DESCRIPTION OF THE PREFERRED EMBODIMENTS

An embodiment of the present disclosure will be described hereinafter. Matters not specifically mentioned herein but required for carrying out the present disclosure can be understood as matters of design of a person skilled in the art based on related art in the field. The present disclosure can be carried out on the basis of the contents disclosed in the description and common general knowledge in the field.

A “secondary battery” herein refers to a power storage device capable of being repeatedly charged and discharged, and includes a so-called storage battery and a power storage element such as an electric double layer capacitor. A “lithium ion secondary battery” herein refers to a secondary battery that uses lithium ions as charge carriers and performs charge and discharge by movement of charges accompanying lithium ions between positive and negative electrodes.

A nonaqueous electrolyte according to this embodiment includes, as essential components, an electrolyte salt, a nonaqueous solvent, and a compound represented by following Chemical Formula (I):

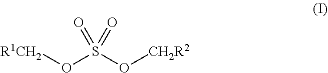

In the formula, each of R¹ and R² independently represents a trifluoromethyl group, a secondary alkyl group having 3 to 6 carbon atoms, or a tertiary alkyl group having 4 to 6 carbon atoms.

As the electrolyte salt, a known electrolyte salt used as an electrolyte salt of a nonaqueous electrolyte secondary battery (particularly lithium ion secondary battery) can be used without any particular limitation. The electrolyte salt is desirably a lithium salt containing fluorine atoms. Examples of the lithium salt includes LiPF₆, LiBF₄, lithium bis(fluorosulfonyl)imide (LiFSI), and lithium bis(trifluoromethane)sulfonimide (LiTFSI). Among these, LiPF₆ is desirable. These may be used alone or two or more of them may be used in combination.

A concentration of the electrolyte salt in the nonaqueous electrolyte may be appropriately determined depending on the type of the electrolyte salt. The concentration of the electrolyte salt in the nonaqueous electrolyte is typically 0.5 mol/L or more and 5 mol/L or less, and desirably 0.7 mol/L or more and 2.5 mol/L or less.

The nonaqueous solvent dissolves the electrolyte salt described above therein. The type of the nonaqueous solvent is not specifically limited as long as the electrolyte salt can be dissolved therein. Examples of the nonaqueous solvent includes carbonates, ethers, esters, nitriles, and sulfones. Among these, carbonates are desirable.

Examples of carbonates include: chain carbonates such as dimethyl carbonate (DMC), diethyl carbonate (DEC), ethyl methyl carbonate (EMC), and methylpropyl carbonate; and cyclic carbonates such as ethylene carbonate (EC), propylene carbonate (PC), and butylene carbonate. These may be used alone or two or more of them may be used in combination, and it is desirable to use a combination of a chain carbonate and a cyclic carbonate.

Carbonates are desirably at least one carbonate selected from the group consisting of dimethyl carbonate, ethyl methyl carbonate, and ethylene carbonate, and more desirably a combination of ethylene carbonate and one or both of dimethyl carbonate and ethyl methyl carbonate.

The compound represented by Chemical Formula (I) above (hereinafter also referred to as a “sulfate ester compound (I)”) functions as a coating forming component. In the sulfate ester compound (I) used in this embodiment, R¹ and R² are bonded to oxygen atoms in a SO₄ moiety through a methylene group (—CH₂—). Each of R¹ and R² is a trifluoromethyl group, a secondary alkyl group having 3 to 6 carbon atoms, or a tertiary alkyl group having 4 to 6 carbon atoms, and thus, is a sterically bulky alkyl group.

In general, in a nonaqueous electrolyte including a sulfate ester-based compound, sulfate anions are generated by hydrolysis or other reactions in a battery, and contribute to coating formation. Here, if the sulfate ester-based compound is susceptible to hydrolysis, stability in the nonaqueous electrolyte decreases, and thus, sulfate anions cannot be generated efficiently at the electrode interface. A coating is basically an insulator, and thus, easily increases an initial resistance of the battery.

In the sulfate ester compound (I) used in this embodiment, the bulky alkyl group is bonded to oxygen atoms in the SO₄ moiety through the methylene group. This bulky alkyl group functions as a protecting group to suppress hydrolysis of the sulfate ester compound (I), and as a result, sulfate anions are efficiently generated at the electrode interface, which can modify the coating. That is, thereby the coating can be modified to have a lower resistance, and redundant side reaction between a highly active electrode and the nonaqueous electrolyte can be reduced. Accordingly, both initial output characteristics and high-temperature storage characteristics of the nonaqueous electrolyte secondary battery can be enhanced.

Examples of the secondary alkyl group having 3 to 6 carbon atoms represented by R¹ and R² include an isopropyl group, a sec-butyl group, a 1-methylbutyl group, a 1-ethylpropyl group, a 1-methylpentyl group, a 1-ethylbutyl group, a cyclopentyl group, and a cyclohexyl group.

Examples of the tertiary alkyl group having 4 to 6 carbon atoms represented by R¹ and R² include a tert-butyl group, a 1,1-dimethylpropyl group, a 1-ethyl-1-methylpropyl group, a 1,1,2-trimethylpropyl group, and a 1,1-dimethylbutyl group.

Each of R¹ and R² is desirably a trifluoromethyl group, an isopropyl group, a sec-butyl group, or a tert-butyl group.

The content of the sulfate ester compound (I) in the nonaqueous electrolyte is not specifically limited. However, if the content of the sulfate ester compound (I) in the nonaqueous electrolyte is excessively small, the effect of enhancing initial output characteristics and the effect of enhancing high-temperature storage characteristics decrease. Thus, the content of the sulfate ester compound (I) in the nonaqueous electrolyte is desirably 0.05 mass % or more, more desirably 0.1 mass % or more, and even more desirably 0.5 mass % or more. On the other hand, if the content of the sulfate ester compound (I) in the nonaqueous electrolyte is excessively large, the effect of enhancing high-temperature storage characteristics decreases. Thus, the content of the sulfate ester compound (I) in the nonaqueous electrolyte is desirably 3.0 mass % or less, more desirably 2.0 mass % or less, and even more desirably 1.5 mass % or less.

The nonaqueous electrolyte according to this embodiment may further include a compound represented by following Chemical Formula (II) (hereinafter also referred to as an “oxalatoborate compound (II)”).

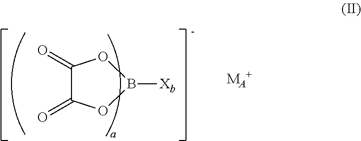

In the formula, X represents a halogen atom, M_{A}⁺ represents an alkali metal ion, a is 1 or 2, and b is 2 if a is 1, or is 0 if a is 2.

The oxalatoborate compound (II) is also a compound contributing formation of a coating. In a case where the nonaqueous electrolyte according to this embodiment includes the oxalatoborate compound (II), thereby high-temperature storage characteristics (particularly resistance to capacity decrease in high-temperature storage) is further enhanced. Initial output characteristics can also be further enhanced. This is supposed to be because a composite coating derived from sulfate anions generated from the sulfate ester compound (I) and a decomposition product of the oxalatoborate compound (II) is formed, and the coating can be much further modified.

In Chemical Formula (II) above, examples of the halogen atom represented by X include a fluorine atom, a chlorine atom, a bromine atom, and an iodide atom. Among these atoms, the fluorine atom is desirable.

In Chemical Formula (II) above, examples of the alkali metal ion represented by M_{A}⁺ include a lithium ion, a sodium ion, and potassium ion. Among these ions, the lithium ion and the sodium ion are desirable, and the lithium ion is particularly desirable.

As the oxalatoborate compound (II), compounds within the range of Chemical Formula (II) above may be used alone or two or more of them may be used in combination. The oxalatoborate compound (II) is particularly desirably one compound selected from the group consisting of lithium bis(oxalato)borate (LiBOB) and lithium difluoro(oxalato)borate (LiDFOB). From the viewpoint of highly suppressing resistance increase in high-temperature storage, LiBOB is more desirable. From the viewpoint of higher initial output characteristics, LiDFOB is more desirable.

The content of the oxalatoborate compound (II) in the nonaqueous electrolyte is not specifically limited. However, if the content of the oxalatoborate compound (II) is excessively small, the effect of further enhancing high-temperature storage characteristics decreases. Thus, the content of the oxalatoborate compound (II) is desirably 0.05 mass % or more, more desirably 0.1 mass % or more, and even more desirably 0.3 mass % or more. On the other hand, if the content of the oxalatoborate compound (I) is excessively large, the effect of further enhancing initial output characteristics cannot be obtained. Thus, the content of the oxalatoborate compound (II) is desirably 1.0 mass % or less, and more desirably 0.7 mass % or less.

The nonaqueous electrolyte according to this embodiment may further include a compound represented by following Chemical Formula (III) (hereinafter also referred to as “difluorophosphate (III)”).

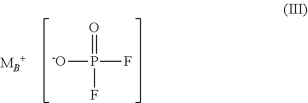

In the formula, M_{B}⁺ represents an alkali metal ion.

In a case where the nonaqueous electrolyte according to this embodiment includes difluorophosphate (III) in addition to the oxalatoborate compound (II), the effect of enhancing initial output characteristics further increases, and high-temperature storage characteristics (particularly performance of suppressing resistance increase in high-temperature storage) also further increases. This is supposed to be because a composite coating derived from sulfate anions generated from the sulfate ester compound (I), a decomposition product of the oxalatoborate compound (II), and phosphate anions generated from the difluorophosphate (III) is formed, and the coating can be further modified.

The nonaqueous electrolyte according to this embodiment may use a combination of the sulfate ester compound (I) and the difluorophosphate (III) without using the oxalatoborate compound (II). As the difluorophosphate (III), compounds within the range of Chemical Formula (III) above may be used alone or two or more of them may be used in combination.

In Chemical Formula (III) above, examples of the alkali metal ion represented by M_{B}⁺ include a lithium ion, a sodium ion, and a potassium ion. Among these ions, the lithium ion and the sodium ion are desirable, and the lithium ion is particularly desirable.

The content of the difluorophosphate (III) in the nonaqueous electrolyte is not specifically limited. However, if the content of the difluorophosphate (III) is excessively small, the effect of suppressing a resistance increase in high-temperature storage decreases. Thus, the content of the difluorophosphate (III) is desirably 0.05 mass % or more, more desirably 0.1 mass % or more, and even more desirably 0.5 mass % or more. On the other hand, the content of the difluorophosphate (III) is desirably 3.0 mass % or less, and more desirably 2.0 mass % or less. In a case where the content of the difluorophosphate (III) is 1.0 mass % or more and 2.0 mass % or less, the nonaqueous electrolyte secondary battery can obtain especially high levels of both initial output characteristics and high-temperature storage characteristics.

The nonaqueous electrolyte according to this embodiment may further include other additives (e.g., positive/negative electrode coating forming agents such as vinylene carbonate (VC), fluoroethylene carbonate (FEC), and 1,3-propane sultone (PS); and overcharge inhibitors such as biphenyl (BP), cyclohexylbenzene (CHB), t-butylbenzene, and t-amylbenzene), within a range that does not significantly impair the effects of the present disclosure.

The nonaqueous electrolyte according to this embodiment can be used for a nonaqueous electrolyte secondary battery according to a known method. Thus, the nonaqueous electrolyte is typically a nonaqueous electrolyte for a nonaqueous electrolyte secondary battery, and desirably a nonaqueous electrolyte for a lithium ion secondary battery. The nonaqueous electrolyte according to this embodiment can achieve high levels of both initial output characteristics and high-temperature storage characteristics in a nonaqueous electrolyte secondary battery.

In view of this, in another aspect, a nonaqueous electrolyte according to this embodiment includes a positive electrode, a negative electrode, and the nonaqueous electrolyte described above.

As a configuration example of the nonaqueous electrolyte according to this embodiment, a general configuration of a lithium ion secondary battery including the nonaqueous electrolyte described above will be described with reference to the drawings. The following lithium ion secondary battery is an example, and is not intended to limit the nonaqueous electrolyte according to this embodiment secondary battery. In the drawings, members and parts having the same functions are denoted by the same reference characters for description. Dimensional relationships (e.g., length, width, and thickness) in the drawings do not reflect actual dimensional relationships.

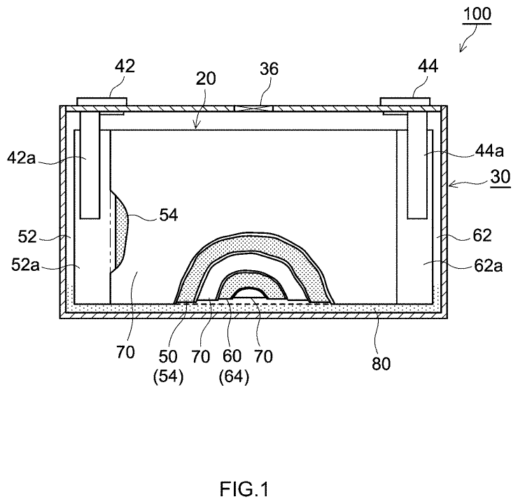

A lithium ion secondary battery 100 illustrated in FIG. 1 is a sealed battery in which a flat wound electrode body 20 and a nonaqueous electrolyte 80 are housed in a flat square battery case (i.e., outer container) 30. The battery case 30 includes a positive electrode terminal 42 and a negative electrode terminal 44 for external connection, and a thin safety valve 36 configured such that when the internal pressure of the battery case 30 increases to a predetermined level or more, the safety valve 36 releases the internal pressure. The battery case 30 has an injection port (not shown) for injecting the nonaqueous electrolyte 80. The positive electrode terminal 42 is electrically connected to a positive electrode current collector plate 42a. The negative electrode terminal 44 is electrically connected to a negative electrode current collector plate 44a. A material for the battery case 30 is, for example, a metal material that is lightweight and has high thermal conductivity, such as aluminium.

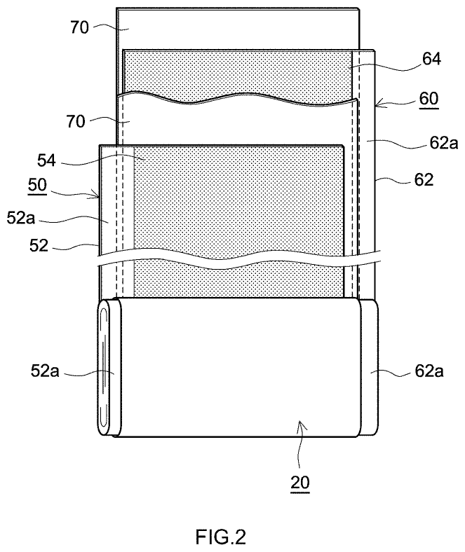

As illustrated in FIGS. 1 and 2, in the wound electrode body 20, a positive electrode sheet 50 and a negative electrode sheet 60 are stacked with two long separator sheets 70 interposed therebetween and wound in the longitudinal direction. In the positive electrode sheet 50, a positive electrode active material layer 54 is formed on one or each (each in this example) surface of a long positive electrode current collector 52 along the longitudinal direction. In the negative electrode sheet 60, a negative electrode active material layer 64 is formed on one or each (each in this example) of a long negative electrode current collector 62 along the longitudinal direction. The positive electrode active material layer non-formed portion 52a (i.e., a portion where no positive electrode active material layer 54 is formed and the positive electrode current collector 52 is exposed) and the negative electrode active material layer non-formed portion 62a (i.e., a portion where none of the negative electrode active material layer 64 and the coating layer 66 is formed and the negative electrode current collector 62 is exposed) extend off outward from both ends of the wound electrode body 20 in the winding axis direction (i.e., sheet width direction orthogonal to the longitudinal direction). The positive electrode current collector plate 42a and the negative electrode current collector plate 44a are respectively coupled to the positive electrode active material layer non-formed portion 52a and the negative electrode active material layer non-formed portion 62a.

The positive electrode current collector 52 constituting the positive electrode sheet 50 may be a known positive electrode current collector for use in a lithium ion secondary battery, and examples of the positive electrode current collector 52 include sheets or foil of highly conductive metals (e.g., aluminium, nickel, titanium, and stainless steel). The positive electrode current collector 52 is desirably aluminium foil.

Dimensions of the positive electrode current collector 52 are not specifically limited, and may be appropriately determined depending on battery design. In the case of using aluminium foil as the positive electrode current collector 52, the thickness thereof is not specifically limited, and is, for example, 5 μm or more and 35 m or less, and desirably 7 μm or more and 20 μm or less.

The positive electrode active material layer 54 includes a positive electrode active material. The positive electrode active material may be a known positive electrode active material for use in a lithium ion secondary battery. Specifically, as the positive electrode active material, a lithium composite oxide or a lithium transition metal lithium composite oxide, for example, may be used. The crystal structure of the positive electrode active material is not specifically limited, and may be, for example, a layered structure, a spinel structure, or an olivine structure.

The lithium composite oxide is desirably a lithium transition metal composite oxide including at least one of Ni, Co, or Mn as a transition metal element, and specific examples of the lithium composite oxide include a lithium nickel composite oxide, a lithium cobalt composite oxide, a lithium manganese composite oxide, a lithium nickel manganese composite oxide, a lithium nickel cobalt manganese composite oxide, a lithium nickel cobalt aluminium composite oxide, and a lithium iron nickel manganese composite oxide. These positive electrode active materials can be used alone or two or more of them may be used in combination.

The “lithium nickel cobalt manganese composite oxide” herein includes not only oxides including Li, Ni, Co, Mn, and O as constituent elements, but also an oxide including one or more additive elements. Examples of the additive elements include transition metal elements such as Mg, Ca, Al, Ti, V, Cr, Y, Zr, Nb, Mo, Hf, Ta, W, Na, Fe, Zn, and Sn and typical metal elements. The additive element may be a metalloid element such as B, C, Si, or P, and a nonmetal element such as S, F, Cl, Br, or I. This also holds for, for example, lithium nickel composite oxide, lithium cobalt composite oxide, lithium manganese composite oxide, lithium nickel cobalt manganese composite oxide, lithium nickel cobalt aluminium composite oxide, and lithium iron nickel manganese composite oxide.

Examples of the lithium transition metal lithium composite oxide include lithium iron phosphate (LiFePO₄), lithium manganese phosphate (LiMnPO₄), and lithium manganese iron phosphate.

The positive electrode active material is particularly desirably a lithium nickel cobalt manganese composite oxide.

The average particle size (median particle size: D50) of the positive electrode active material is not specifically limited, and is, for example, 0.05 μm or more and 25 μm or less, desirably 1 μm or more and 20 μm or less, and more desirably 3 μm or more and 15 μm or less. The average particle size (D50) of the positive electrode active material can be obtained by, for example, a laser diffraction and scattering method.

The positive electrode active material layer 54 may include components other than the positive electrode active material, such as trilithium phosphate, a conductive agent, and a binder. Preferred examples of the conductive agent include: carbon black such as acetylene black (AB); and other carbon materials (e.g., graphite). Examples of the binder include polyvinylidene fluoride (PVdF).

The content of the positive electrode active material in the positive electrode active material layer 54 (i.e., content of the positive electrode active material in the total mass of the positive electrode active material layer 54) is not specifically limited, and is desirably 70 mass % or more, more desirably 80 mass % or more and 97 mass % or less, and much more desirably 85 mass % or more and 96 mass % or less. The content of trilithium phosphate in the positive electrode active material layer 54 is not specifically limited, and is desirably 1 mass % or more and 15 mass % or less, and more desirably 2 mass % or more and 12 mass % or less. The content of the conductive material in the positive electrode active material layer 54 is not specifically limited, and is desirably 1 mass % or more and 15 mass % or less, and more desirably 3 mass % or more and 13 mass % or less. The content of the binder in the positive electrode active material layer 54 is not specifically limited, and is desirably 4 mass % or more and 15 mass % or less, and more desirably 1.5 mass % or more and 10 mass % or less.

The thickness of the positive electrode active material layer 54 is not specifically limited, and is, for example, 10 μm or more and 300 μm or less, and desirably 20 m or more and 200 μm or less.

As the negative electrode current collector 62 constituting the negative electrode sheet 60, a known negative electrode current collector for use in a lithium ion secondary battery may be used, and examples of the negative electrode current collector include sheets or foil of highly conductive metals (e.g., copper, nickel, titanium, and stainless steel). The negative electrode current collector 62 is desirably copper foil.

Dimensions of the negative electrode current collector 62 are not specifically limited, and may be appropriately determined depending on battery design. In the case of using copper foil as the negative electrode current collector 62, the thickness thereof is not specifically limited, and is, for example, 5 μm or more and 35 μm or less, and desirably 7 μm or more and 20 μm or less.

The negative electrode active material layer 64 includes a negative electrode active material. Examples of the negative electrode active material include carbon materials such as graphite, hard carbon, and soft carbon. Graphite may be natural graphite or artificial graphite, and may be amorphous carbon-coated graphite in which graphite is coated with an amorphous carbon material.

The average particle size (median particle size: D50) of the negative electrode active material is not specifically limited, and is, for example, 0.1 μm or more and 50 μm or less, desirably 1 μm or more and 25 μm or less, and more desirably 5 μm or more and 20 μm or less. The average particle size (D50) of the negative electrode active material can be obtained by, for example, a laser diffraction and scattering method.

The negative electrode active material layer 64 can include components other than the active material, such as a binder or a thickener. Examples of the binder include styrene-butadiene rubber (SBR) and polyvinylidene fluoride (PVDF). Examples of the thickener include carboxymethyl cellulose (CMC).

The content of the negative electrode active material in the negative electrode active material layer 64 is desirably 90 mass % or more, and more desirably 95 mass % or more and 99 mass % or less. The content of the binder in the negative electrode active material layer 64 is desirably 0.1 mass % or more and 8 mass % or less, and more desirably 0.5 mass % or more and 3 mass % or less. The content of the thickener in the negative electrode active material layer 64 is desirably 0.3 mass % or more and 3 mass % or less, and more desirably 0.5 mass % or more and 2 mass % or less.

The thickness of the negative electrode active material layer 64 is not specifically limited, and is, for example, 10 μm or more and 300 μm or less, and desirably 20 m or more and 200 μm or less.

Examples of the separator 70 include a porous sheet (film) of a resin such as polyethylene (PE), polypropylene (PP), polyester, cellulose, and polyamide. The porous sheet may have a single-layer structure or a laminated structure of two or more layers (e.g., three-layer structure in which PP layers are stacked on both surfaces of a PE layer). A heat-resistance layer (HRL) may be provided on a surface of the separator 70.

The thickness of the separator 70 is not specifically limited, and is, for example, m or more and 50 μm or less, and desirably 10 μm or more and 30 μm or less. An air permeability of the separator 70 obtained by a Gurley permeability test is not specifically limited, and desirably 350 sec./100 cc or less.

The nonaqueous electrolyte 80 can be the nonaqueous electrolyte according to this embodiment. FIG. 1 does not strictly illustrate the amount of the nonaqueous electrolyte 80 injected into the battery case 30.

The thus-configured lithium ion secondary battery 100 has a low initial resistance, and thus, shows excellent initial output characteristics. In the lithium ion secondary battery 100, resistance increase and capacity decrease in storage at high temperatures are suppressed. That is, the lithium ion secondary battery 100 has excellent high-temperature storage characteristics.

The lithium ion secondary battery 100 is applicable to various applications. Examples of preferred application include a drive power supply to be mounted on a vehicle such as a battery electric vehicle (BEV), a hybrid electric vehicle (HEV), and a plug-in hybrid electric vehicle (PHEV). The lithium ion secondary battery 100 can be used as a storage battery for, for example, a small-size power storage device. The lithium ion secondary battery 100 can be used in a battery assembly in which a plurality of batteries are typically connected in series and/or in parallel.

The foregoing description is directed to the square lithium ion secondary battery 100 including the flat wound electrode body 20 as an example. Alternatively, the nonaqueous electrolyte secondary battery disclosed here can also be configured as a lithium ion secondary battery including a laminated electrode body (i.e., electrode body in which a plurality of positive electrodes and a plurality of negative electrodes are alternately stacked). The nonaqueous electrolyte secondary battery disclosed here may also be configured as a cylindrical lithium ion secondary battery, a laminated case type lithium ion secondary battery, or a coin type lithium ion secondary battery, for example. The nonaqueous electrolyte secondary battery disclosed here may also be configured as a nonaqueous electrolyte secondary battery other than a lithium ion secondary battery in accordance with a known method.

Examples of the present invention will now be described, but are not intended to limit the present technique to these examples.

### Test Example 1: Examples 1-1 to 1-5 and Comparative Examples 1-1 to 1-4

### <Preparation of Nonaqueous Electrolyte>

As a nonaqueous solvent, a mixed solvent including ethylene carbonate (EC), dimethyl carbonate (DMC), and ethyl methyl carbonate (EMC) at a volume ratio of EC:DMC:EMC=30:40:30 was prepared. In this mixed solvent, LiPF₆ was dissolved in a concentration of 1.0 mol/L (1.0 M). The sulfate ester compound shown in Table 1 is added to the resulting solvent to have the content (mass %) shown in Table 1, thereby obtaining nonaqueous electrolytes of examples and comparative examples.

<Preparation of Evaluation Lithium Ion Secondary Battery>

First, LiNi_{1/3}Co_{1/3}Mn_{1/3}O₂(NCM) as positive electrode active material powder, acetylene black (AB) as a conductive agent, and polyvinylidene fluoride (PVdF) as a binder were mixed with N-methylpyrrolidone (NMP) at a mass ratio of NCM:AB:PVdF=87:10:3, thereby preparing positive electrode active material layer slurry. This slurry was applied onto aluminium foil and dried, thereby producing a positive electrode sheet.

A natural graphite-based carbon material (C) having an average particle size of m as a negative electrode active material, styrene-butadiene rubber (SBR) as a binder, and carboxymethyl cellulose (CMC) as a thickener were mixed with ion-exchanged water at a mass ratio of C:SBR:CMC=98:1:1, thereby preparing negative electrode active material layer slurry. This slurry was applied onto copper foil and dried, thereby producing a negative electrode sheet.

As a separator, a polyolefin porous film having a three-layer structure of PP/PE/PP whose air permeability obtained by a Gurley permeability test was 300 sec./100 cc was prepared.

The obtained positive electrode sheet and negative electrode sheet were placed to face each other with a separator interposed therebetween, thereby producing an electrode body. A current collector terminal was attached to the obtained electrode body, and housed in a laminated case together with the nonaqueous electrolytes of the examples and the comparative examples, and sealed. In this manner, evaluation lithium ion secondary batteries according to the examples and the comparative examples were fabricated.

<Activation Treatment>

Each of the thus-fabricated evaluation lithium ion secondary batteries was placed in a thermostat at 25° C. Each evaluation lithium ion secondary battery was charged with a constant current to 4.10 V with a current value of 0.3 C. Thereafter, the battery was discharged with a constant current to 3.00 V with a current value of 0.3 C. This charge and discharge process is repeated three times, thereby performing an activation treatment.

<Initial Characteristic Evaluation>

Each of the thus-activated evaluation lithium ion secondary batteries was charged with a constant current to 4.10 V with a current value of 0.2 C, and then, subjected to constant-current/constant-voltage charging of performing constant-voltage charging to a current value of 1/50 C to be thereby fully charged. Subsequently, the battery was discharged with a constant current to 3.00 V with a current value of 0.2 C. A discharge capacity at this time was measured and defined as an initial capacity.

Each evaluation lithium ion secondary battery was charged with the initial capacity set at an SOC of 100% in a thermostat at 25° C. with a current value of 0.3 C until the charge depth (SOC) reached 30%. Then, in the thermostat at 25° C., the battery was discharged for 10 seconds with current values of 5 C, 15C, 30 C, and 45 C, and battery voltages after discharge with the current values were measured. Current values and battery voltages were plotted to obtain I-V characteristics in discharge, and from the slope of the obtained line, an IV resistance (Q) was obtained as an initial resistance. Ratios of initial resistances of other evaluation lithium ion secondary batteries to the evaluation lithium ion secondary battery of Comparative Example 1 in a case where the initial resistance of the evaluation lithium ion secondary battery of Comparative Example 1 was 100 were obtained. Table 1 shows the results.

<High-temperature Storage Characteristic Evaluation>

Each of the thus-activated evaluation lithium ion secondary batteries was charged with a current value of 0.3 C until the SOC reached 100%. The evaluation lithium ion secondary battery was placed in a thermostat at 75° C. and stored for one month. Thereafter, with the same method as described above, a remaining capacity and an IV resistance were measured. From Equation: (battery capacity after high-temperature storage/initial capacity)×100, a remaining capacity (%) after high-temperature storage was obtained. From equation: (battery resistance after high-temperature storage/initial resistance−1)×100, resistance change (%) after high-temperature storage was obtained. Table 1 shows the results.

TABLE 1

| | | | | Remaining | Resistance |
|---|---|---|---|---|---|
| | | | | After High- | High - |
| | | | | temperature | temperature |
| | Sulfate Ester | | Initial Resistance | Storage (%) | Storage (%) |
| | Type | Content (mass %) | Ratio | Capacity | Change After |
| Comparative | — | 0 | 100 | 55.0 | 39.1 |
| Example 1-1 | | | | | |
| Example 1-1 | (CF₃CH₂)₂SO₄ | 1.0 | 98 | 68.1 | 14.5 |
| Example 1-2 | ((CH₃)₂CHCH₂)₂SO₄ | 1.0 | 98 | 67.5 | 15.4 |
| Example 1-3 | ((CH₃)₃CCH₂)₂SO₄ | 1.0 | 98 | 68.7 | 13.9 |
| Example 1-4 | (CF₃CH₂)₂SO₄ | 0.05 | 99 | 57.5 | 26.3 |
| Example 1-5 | (CF₃CH₂)₂SO₄ | 3.0 | 97 | 68.3 | 15.3 |
| Comparative | dimethyl sulfate | 1.0 | 101 | 42.5 | 29.3 |
| Example 1-2 | | | | | |
| Comparative | diethyl sulfate | 1.0 | 102 | 43.1 | 30.5 |
| Example 1-3 | | | | | |
| Comparative | ethylene sulfate | 1.0 | 105 | 60.7 | 36.8 |
| Example 1-4 | | | | | |

A comparison between Comparative Example 1-1 and the other test examples shows that the use of a sulfate ester as an additive enhances high-temperature storage characteristics. This is because a coating derived from the sulfate ester is formed on an electrode. However, in Comparative Examples 1-2 to 1-4, the coating derived from the sulfate ester increased initial resistance. On the other hand, in Examples 1-1 to 1-5, the initial resistance was low. In addition, a comparison between Examples 1-1 to 1-3 and Comparative Examples 1-2 to 1-4 using the same amount of the sulfate ester demonstrates that Examples 1-1 to 1-3 show higher degrees of enhancement of high-temperature storage characteristics.

In an alkyl group of the sulfate ester used in Examples 1-1 to 1-5, a trifluoromethyl group, an isopropyl group, or a tert-butyl group, which is a bulky group, is bonded to a methylene group (—CH₂—). Thus, it can be understood that a sulfate ester in which a bulky alkyl group is bonded to an oxygen atom in a SO₄ moiety through a methylene group can modify a coating formed on an electrode, so that both initial resistance reduction (i.e., enhancement of initial output characteristics) and enhancement of high-temperature storage characteristics can be thereby achieved at the same time.

Accordingly, it can be understood that the nonaqueous electrolyte disclosed here can provide a secondary battery with excellent initial output characteristics and excellent high-temperature storage characteristics.

### Test Example 2: Examples 2-1 to 2-3

### <Preparation of Nonaqueous Electrolyte>

As a nonaqueous solvent, a mixed solvent including ethylene carbonate (EC), dimethyl carbonate (DMC), and ethyl methyl carbonate (EMC) at a volume ratio of EC:DMC:EMC=30:40:30 was prepared. In this mixed solvent, LiPF₆ was dissolved at a concentration of 1.0 mol/L (1.0 M). The sulfate ester compound shown in Table 2 was added to the resultant at the concentration (mass %) shown in Table 2, and the oxalatoborate compound shown in Table 2 was also added thereto at the content (mass %) shown in Table 2, thereby obtaining nonaqueous electrolytes of examples and comparative examples.

<Preparation of Evaluation Lithium Ion Secondary Battery>

The thus-obtained nonaqueous electrolytes of the examples and the comparative examples were used to fabricate, activate, and evaluate evaluation lithium ion secondary batteries in the same manner as that in Test Example 1. Evaluation results are shown in Table 2 together with results of Comparative Example 1-1 and Example 1-1.

TABLE 2

| | | | | | | Re- | Resist- |
|---|---|---|---|---|---|---|---|
| | | | | | | maining | ance |
| | | | | | | Capacity | Change |
| | | | | | | After | After |
| | | | | | | High- | High- |
| | Sulfate Ester | | Oxalatoborate | | Initial | tem- | tem- |
| | | Content | | Content | Resist- | perature | perature |
| | | (mass | | (mass | ance | Storage | Storage |
| | Type | %) | Type | %) | Ratio | (%) | (%) |
| Comparative | — | 0 | — | 0 | 100 | 55.0 | 39.1 |
| Example 1-1 | | | | | | | |
| Example 1-1 | (CF₃CH₂)₂SO₄ | 1.0 | — | 0 | 98 | 68.1 | 14.5 |
| Example 2-1 | (CF₃CH₂)₂SO₄ | 1.0 | LiBOB | 0.5 | 95 | 72.5 | 14.4 |
| Example 2-2 | (CF₃CH₂)₂SO₄ | 1.0 | LiBOB | 0.1 | 94 | 70.1 | 14.2 |
| Example 2-3 | (CF₃CH₂)₂SO₄ | 1.0 | LIBOB | 1.0 | 98 | 72.6 | 13.5 |

The results shown in Table 2 show that the combination use of the specific sulfate ester compound and the oxalatoborate compound further enhances high-temperature storage characteristics (particularly resistance to capacity decrease in high-temperature storage). It was also shown that initial output characteristics are also further enhanced in a region with a small content of the oxalatoborate compound.

### Test Example 3: Examples 3-1 to 3-12 and Comparative Examples 3-1 to 3-3

### <Preparation of Nonaqueous Electrolyte>

As a nonaqueous solvent, a mixed solvent including ethylene carbonate (EC), dimethyl carbonate (DMC), and ethyl methyl carbonate (EMC) at a volume ratio of EC DMC:EMC=30:40:30 was prepared. In this mixed solvent, LiPF₆ was dissolved at a concentration of 1.0 mol/L (1.0 M). The sulfate ester compound shown in Table 3 was added to the resultant at the concentrations (mass %) shown in Table 3, and the oxalatoborate compound and difluorophosphate shown in Table 3 were also added thereto at the contents (mass %) shown in Table 3, thereby obtaining nonaqueous electrolytes of examples and comparative examples.

<Preparation of Evaluation Lithium Ion Secondary Battery>

The thus-obtained nonaqueous electrolytes of the examples and the comparative examples were used to fabricate, activate, and evaluate evaluation lithium ion secondary batteries in the same manner as that in Test Example 1. Evaluation results are shown in Table 3 together with results of Comparative Example 1-1, Example 1-1, and Example 2-1.

TABLE 3

| | | | | | | | | Re- | Resist- |
|---|---|---|---|---|---|---|---|---|---|
| | | | | | | | | maining | ance |
| | | | | | | | | Capacity | Change |
| | | | | | | | | After | After |
| | | | | | | | | High- | High- |
| | | | | | | | Initial | tem- | tem- |
| | Sulfate Ester | | Oxalatoborate | | Difluorophosphate | | Resist- | perature | perature |
| | | Content | | Content | | Content | ance | Storage | Storage |
| | Type | (mass %) | Type | (mass %) | Type | (mass %) | Ratio | (%) | (%) |
| Comparative | — | 0 | — | 0 | — | 0 | 100 | 55.0 | 39.1 |
| Example 1-1 | | | | | | | | | |
| Example 1-1 | (CF₃CH₂)₂SO₄ | 1.0 | — | 0 | — | 0 | 98 | 68.1 | 14.5 |
| Example 2- 1 | (CF₃CH₂)₂SO₄ | 1.0 | LiBOB | 0.5 | — | 0 | 95 | 72.5 | 14.4 |
| Example 3-1 | (CF₃CH₂)₂SO₄ | 1.0 | LiBOB | 1.0 | LiPO₂F₂ | 1.0 | 98 | 73.9 | 7.2 |
| Example 3-2 | (CF₃CH₂)₂SO₄ | 1.0 | LiBOB | 0.5 | LiPO₂F₂ | 1.0 | 92 | 73.8 | 7.0 |
| Example 3-3 | (CF₃CH₂)₂SO₄ | 1.0 | LiBOB | 0.1 | LiPO₂F₂ | 1.0 | 86 | 73.5 | 9.1 |
| Example 3-4 | (CF₃CH₂)₂SO₄ | 1.0 | LiBOB | 0.5 | LiPO₂F₂ | 2.0 | 91 | 74.2 | 7.4 |
| Example 3-5 | (CF₃CH₂)₂SO₄ | 1.0 | LiBOB | 0.5 | LiPO₂F₂ | 0.1 | 94 | 73.0 | 9.8 |
| Example 3-6 | (CF₃CH₂)₂SO₄ | 1.0 | LiBOB | 0.5 | LiPO₂F₂ | 0.05 | 94 | 72.8 | 13.1 |
| Example 3-7 | (CF₃CH₂)₂SO₄ | 2.0 | LiBOB | 0.5 | LiPO₂F₂ | 1.0 | 90 | 74.0 | 9.9 |
| Example 3-8 | (CF₃CH₂)₂SO₄ | 0.1 | LiBOB | 0.5 | LiPO₂F₂ | 1.0 | 94 | 72.9 | 9.6 |
| Example 3-9 | (CF₃CH₂)₂SO₄ | 1.0 | LiBOB | 0.5 | NaPO₂F₂ | 1.0 | 94 | 74.1 | 7.8 |
| Example 3-10 | ((CH₃)₂CHCH₂)₂SO₄ | 1.0 | LiBOB | 0.5 | LiPO₂F₂ | 1.0 | 92 | 73.3 | 7.1 |
| Example 3-11 | ((CH₃)₃CCH₂)₂SO₄ | 1.0 | LiBOB | 0.5 | LiPO₂F₂ | 1.0 | 91 | 73.2 | 6.9 |
| Example 3-12 | (CF₃CH₂)₂SO₄ | 1.0 | LiDFOB | 0.5 | LiPO₂F₂ | 1.0 | 88 | 73.5 | 11.8 |
| Comparative | dimethyl sulfate | 1.0 | LiBOB | 0.5 | LiPO₂F₂ | 1.0 | 93 | 44.5 | 24.4 |
| Example 3-1 | | | | | | | | | |
| Comparative | diethyl sulfate | 1.0 | LiBOB | 0.5 | LiPO₂F₂ | 1.0 | 98 | 45.2 | 20.4 |
| Example 3-2 | | | | | | | | | |
| Comparative | ethylene sulfate | 1.0 | LiBOB | 0.5 | LiPO₂F₂ | 1.0 | 100 | 70.2 | 31.3 |
| Example 3-3 | | | | | | | | | |

The results shown in Table 3 demonstrate that the combination use of the specific sulfate ester compound, the oxalatoborate compound, and difluorophosphate can achieve higher levels of both initial output characteristics and high-temperature storage characteristics in a nonaqueous electrolyte secondary battery.

Specific examples of the present disclosure have been described in detail hereinbefore, but are merely illustrative examples, and are not intended to limit the scope of claims. The techniques described in claims include various modifications and changes of the above exemplified specific examples.

What is claimed is:

1. A nonaqueous electrolyte comprising:
an electrolyte salt;
a nonaqueous solvent; and
a compound represented by following Chemical Formula (I): 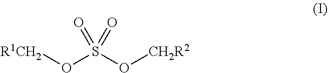
where each of R¹ and R² independently represents a trifluoromethyl group, a secondary alkyl group having 3 to 6 carbon atoms, or a tertiary alkyl group having 4 to 6 carbon atoms.

2. The nonaqueous electrolyte according to claim 1, wherein a content of the compound represented by Chemical Formula (I) is 0.05 mass % or more and 3.0 mass % or less.

3. The nonaqueous electrolyte according to claim 1, further comprising a compound represented by following Chemical Formula (II): 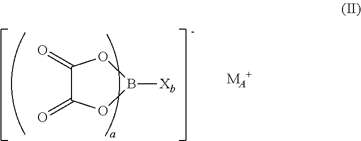
where X represents a halogen atom, M_{A}⁺ represents an alkali metal ion, a is 1 or 2, and b is 2 if a is 1, or is 0 if a is 2.

4. The nonaqueous electrolyte according to claim 3, wherein a content of the compound represented by Chemical Formula (II) is 0.1 mass % or more and 1.0 mass % or less.

5. The nonaqueous electrolyte according to claim 3, further comprising a compound represented by following Chemical Formula (III): 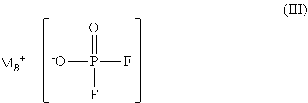
where M_{B}⁺ represents an alkali metal ion.

6. The nonaqueous electrolyte according to claim 5, wherein a content of the compound represented by Chemical Formula (III) is 0.05 mass % or more and 2.0 mass % or less.

7. A nonaqueous electrolyte secondary battery comprising:
a positive electrode;
a negative electrode; and
the nonaqueous electrolyte according to claim 1.
